(19) United States
(12) Patent Application Publication
(10) Pub. No.: US 2006/0023102 A1
(43) Pub. Date: Feb. 2, 2006

(54) Imaging device

(76) Inventors: Hiroki Ueno, Tokyo (JP); Takeshi Kazama, Gifu (JP); Hiroyuki Tsutsui, Kanagawa (JP); Haruo Hayashi, Chiba (JP); Tsuyoshi Kanai, Tokyo (JP)

Correspondence Address: JAY H. MAIOLI;Cooper & Dunham LLP, 1185 Avenue of the Americas, New York, NY, 10036, US

(21) Appl. No.: 11/183,659

(22) Filed: Jul. 18, 2005

(30) Foreign Application Priority Data
Jul. 22, 2004 (JP) P2004-214284

(51) Int. Cl. H04N 5/222

(52) U.S. Cl. 348/333.06

(57) ABSTRACT

An imaging device is composed of a main body casing and a monitor casing, which coincide with each other in their lengthwise direction when not in use at a first position and which, when in use at a second position, are swung relative to each other about a first pivot such that their lengthwise directions form an angle of 90 degrees. The monitor casing is made up of a first casing in which there exists the first pivot and a second casing which is joined to the first casing such that it swings about the second pivot. The first pivot is placed at a position displaced toward the left lateral side from the center of the width of the main body casing so that the second casing is positioned outside the left lateral side of the width of the main body casing when in use at the second position.

### CROSS REFERENCES TO RELATED APPLICATIONS

The present invention contains subject matter related to Japanese Patent Application JP 2004-214284 filed in the Japanese Patent Office on Jul. 22, 2004, the entire contents of which being incorporated herein by reference.

### BACKGROUND OF THE INVENTION

1. Field of the Invention

The present invention relates to an imaging device.

2. Description of the Related Art

There is known a so-called folding portable telephone set which is made up of a main body casing and a monitor casing. The main body casing is a rectangular flat casing having number buttons and function buttons. The monitor casing is a rectangular flat casing having a display. The two casings are swingably joined together by a pivot extending in the direction perpendicular to their lengthwise direction. When in use, the monitor casing is unfolded, and when not in use, the monitor casing is folded (so that the two casings face each other). The portable telephone mentioned above may be incorporated with an imaging device as disclosed in Patent Document 1.

Patent Document 1:

Japanese Patent Laid-open No. 2003-110895

### OBJECT AND SUMMARY OF THE INVENTION

The disadvantage of the above-mentioned imaging device is that the lens barrel and the display surface cannot be directed independently because both the lens barrel and the display are attached to the monitor casing. This makes it inconvenient to take a high-angle picture (in which case the lens barrel is placed above the user's head) or a low-angle picture (in which case the lens barrel is placed below the user's head), with the display plane facing to the user.

In order to tackle this problem, there has been proposed an imaging device which permits the lens barrel and the display surface to be directed independently by contriving the arrangement or the connecting mechanism of the main body casing and the monitor casing.

On the other hand, there is a demand for an imaging device with improved mobility and usefulness. Increasing the display area while reducing the overall size is a serious issue.

The present invention addresses the foregoing and aims at providing an imaging device incorporated into a portable telephone which has a large display area despite its reduced overall size.

One embodiment of the present invention is directed to an imaging device which includes a main body casing of elongate shape with a thickness, a width larger than the thickness, and a length larger than the width, and a monitor casing of elongate shape with a thickness, a width larger than the thickness, and a length larger than the width, the main body casing and the monitor casing being joined together such that they swing about a first pivot extending in the direction of the thickness so that the inside (defining the thickness) of the main body casing and the inside (defining the thickness) of the monitor casing face each other, the monitor casing being divided in its lengthwise direction into a first casing in which there exists the first pivot and a second casing which is joined to the first casing by a second pivot extending in the lengthwise direction such that the second casing swings about the second pivot with respect to the first casing, the main body casing having on its outside (defining its thickness) a lens barrel and the second casing having on its inside (defining its thickness) a display surface to display the image taken by the lens barrel, the main body casing and the monitor casing swinging relative to each other about the first pivot between the non-use position, at which they coincide with each other in their lengthwise direction, and the use position, at which their lengthwise directions form an angle of 90 degrees, and the first pivot being displaced from the center of the width of the main body casing so that the second casing at the use position is positioned outside the lateral side (defining the width) of the main body casing.

Another embodiment of the present invention is directed to a portable telephone which includes a main body casing of elongate shape with a thickness, a width larger than the thickness, and a length larger than the width, and a monitor casing of elongate shape with a thickness, a width larger than the thickness, and a length larger than the width, the main body casing and the monitor casing being joined together such that they swing about a first pivot extending in the direction of the thickness so that the inside (defining the thickness) of the main body casing and the inside (defining the thickness) of the monitor casing face each other, the monitor casing being divided in its lengthwise direction into a first casing in which there exists the first pivot and a second casing which is joined to the first casing by a second pivot extending in the lengthwise direction such that the second casing swings about the second pivot with respect to the first casing, the main body casing and the monitor casing swinging relative to each other about the first pivot between the non-use position, at which they coincide with each other in their lengthwise direction, and the use position, at which their lengthwise directions form an angle of 90 degrees, the main body casing having on its outside (defining the thickness) a lens barrel and also having on that part of its inside (defining the thickness) which is exposed at the use position operating members for operation of the portable telephone, and the second casing having on its inside (defining the thickness) a display surface to display an image taken by the lens barrel, and the first pivot being displaced from the center of the width of the main body casing so that the second casing at the use position is positioned outside the lateral side (defining the width) of the main body casing.

According to the embodiments of the present invention, the first pivot is displaced from the center of the width of the main body casing so that the second casing is positioned outside the lateral side of the main body casing when the monitor casing is at the use position. This arrangement makes the second casing longer than the case in which the first pivot is placed at the center of the width of the main body casing.

Thus the second casing for the display surface can be made large. This is desirable for securing a large space for the display surface while reducing the size of the main body casing and the monitor casing.

The object of providing a sufficient display area while reducing the overall size is achieved by placing the first pivot at a position displaced from the center of the width of the main body casing.

### BRIEF DESCRIPTION OF THE DRAWINGS

The above and other objects, features and advantages of the present invention will become more apparent from the following description of the presently exemplary embodiment of the invention taken in conjunction with the accompanying drawings, in which:

FIG. 1 is a diagram showing the structure of the imaging device according to Example 1;

FIG. 2 is a diagram showing the structure of the imaging device according to Example 1;

FIG. 3 is a perspective view of the imaging device according to FIG. 1 (viewed from front diagonally above);

FIG. 4 is a perspective view of the imaging device according to FIG. 1 (viewed from front diagonally above);

FIG. 5 is a front view of the imaging device shown in FIG. 3;

FIG. 6 is a rear view of the imaging device shown in FIG. 3;

FIG. 7 is a perspective view of the imaging device shown in FIG. 3 (viewed from rear diagonally above);

FIG. 8 is a perspective view of the imaging device shown in FIG. 3 (viewed from rear diagonally above);

FIG. 9 is a diagram showing how the monitor casing is turned;

FIG. 10 is a diagram illustrating the first and second edge members for the main body casing;

FIG. 11 is a perspective view of the monitor casing;

FIG. 12 is a block diagram showing the control system of the imaging device;

FIG. 13 is a diagram showing the structure of the portable telephone; and

FIG. 14 is a block diagram showing the control system of the portable telephone.

### DESCRIPTION OF THE PREFERRED EMBODIMENTS

### EXAMPLE 1

Example 1 of the present invention will be described with reference to the accompanying drawings.

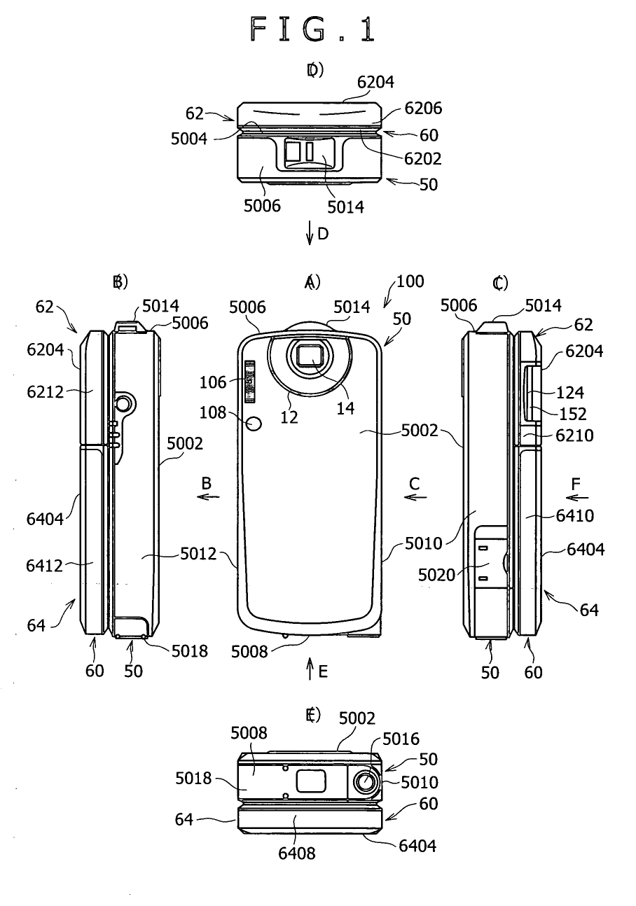

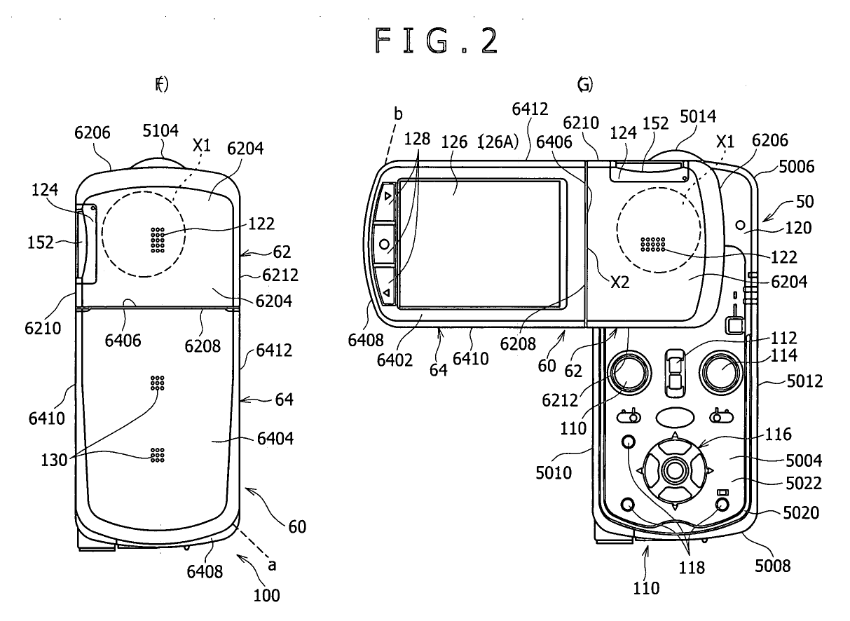

The imaging device according to Example 1 is shown in FIG. 1(A), which is a front view, and FIG. 1(B) to FIG. 1(E), which are side views in the direction of arrows B, C, D, and E, respectively. FIG. 2(F) is a side view in the direction of F in FIG. 1(C). FIG. 2(G) is a diagram showing the imaging device as shown in FIG. 2(F), with its monitor casing swung 90 degrees.

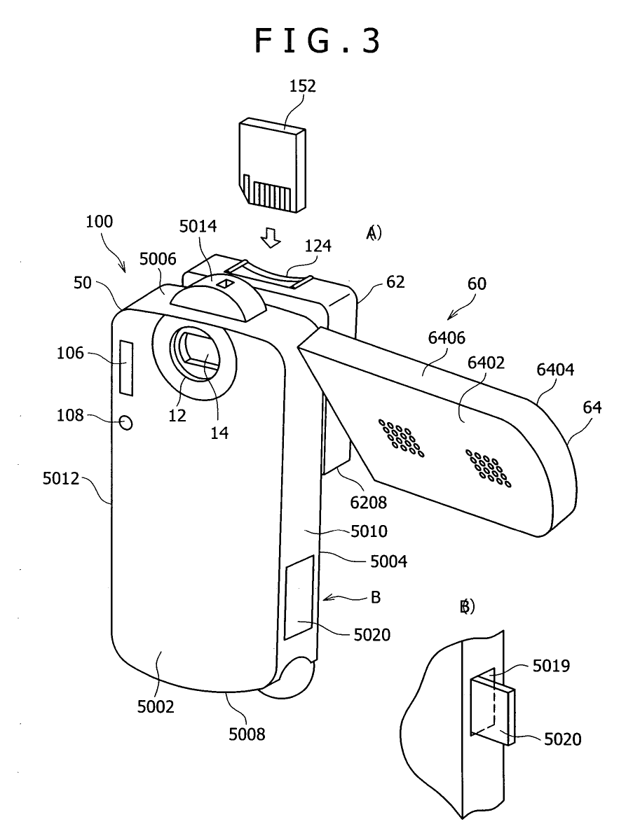

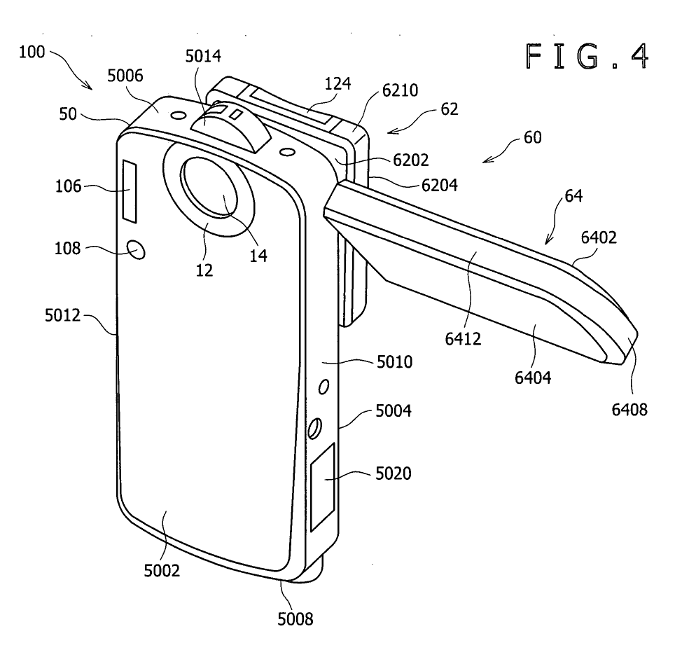

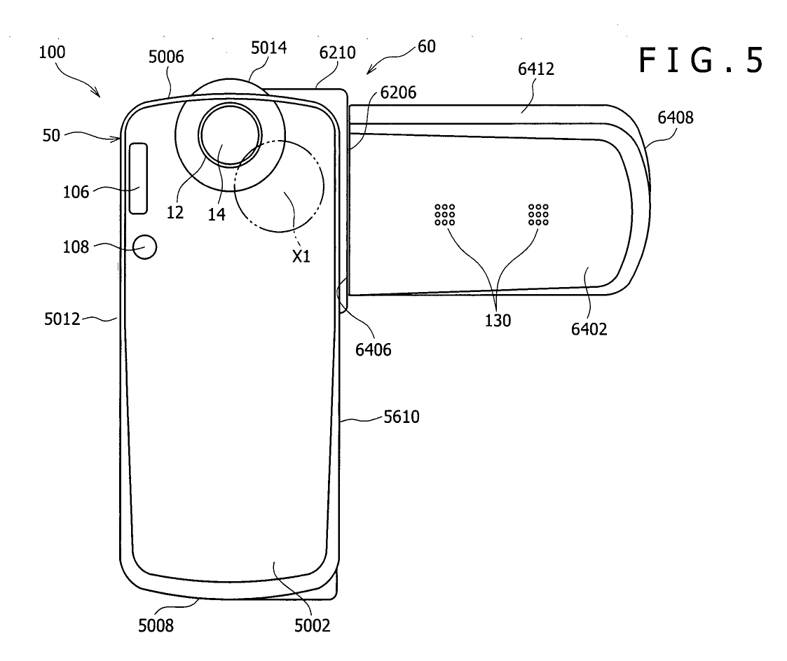

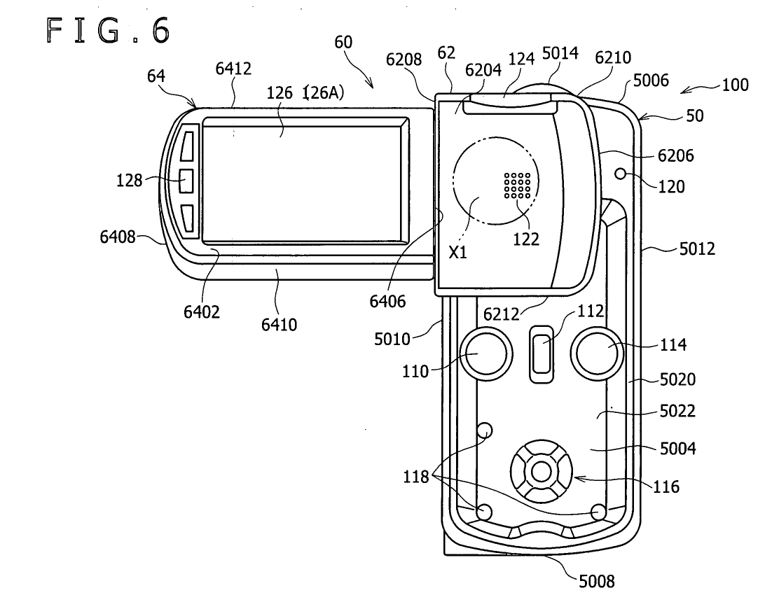

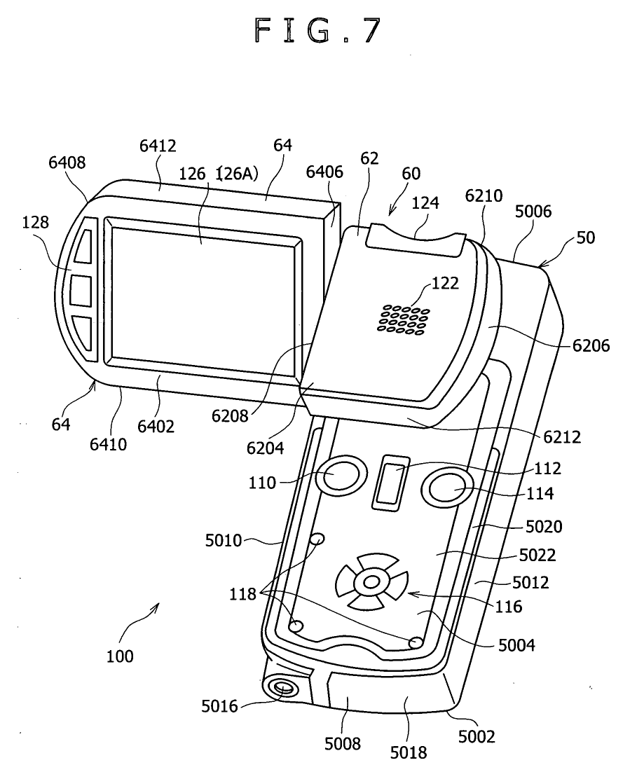

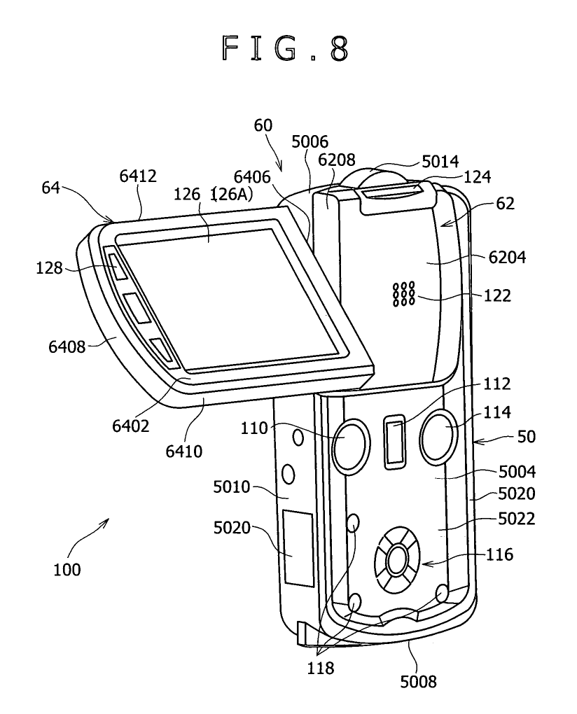

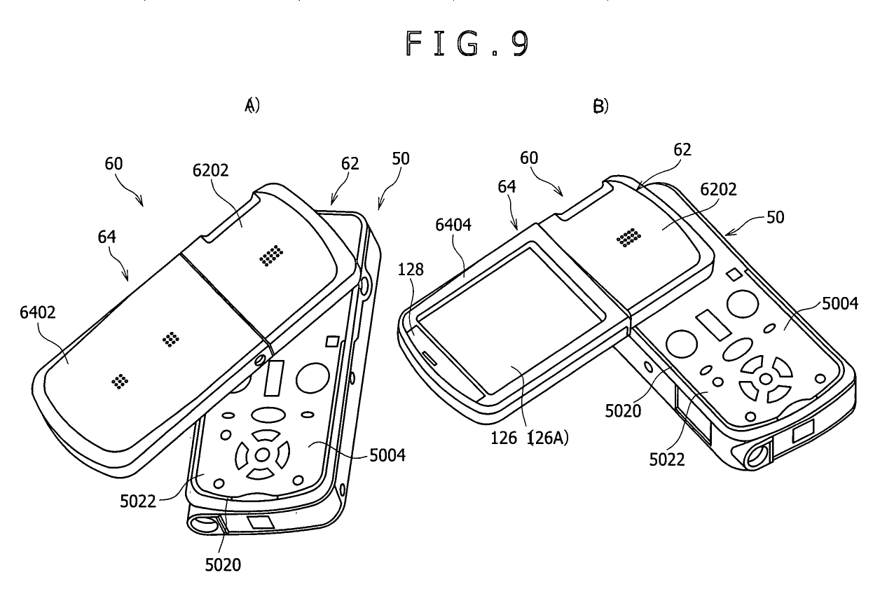

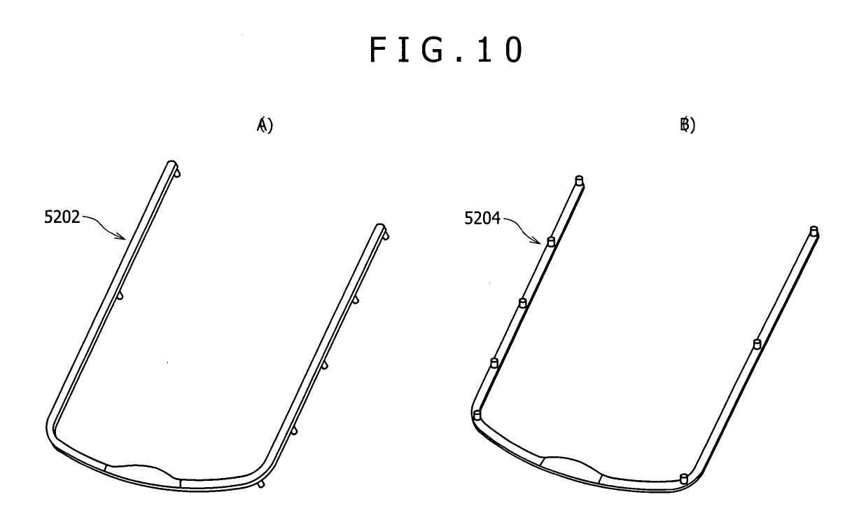

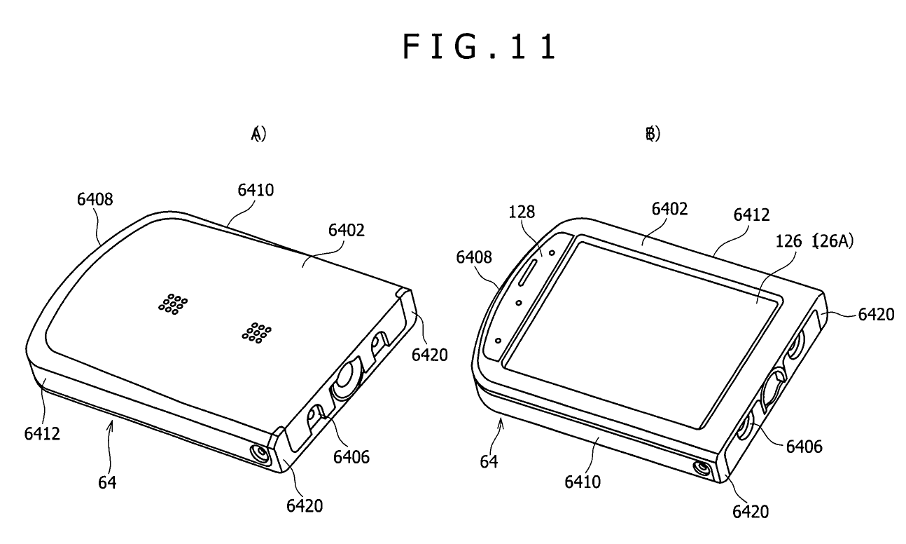

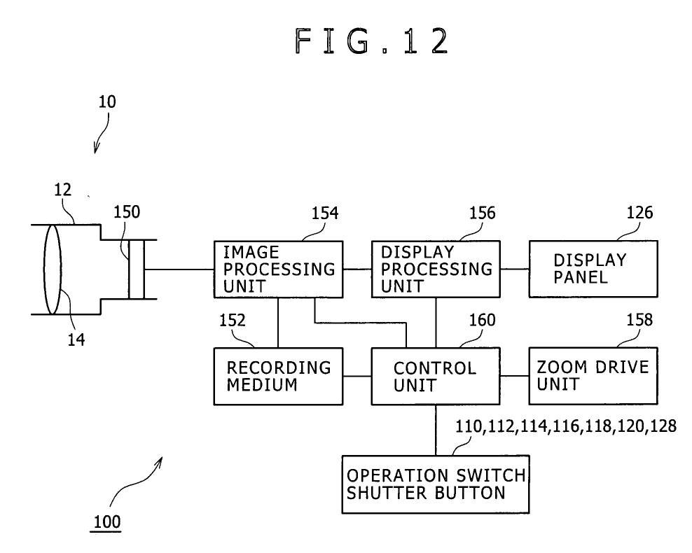

FIG. 3(A) is a perspective view of the imaging device according to Example 1, viewed from front diagonally above. FIG. 3(B) is an enlarged perspective view of part B in FIG. 3(A). FIG. 4 is a perspective view of the imaging device according to Example 1, viewed from front diagonally above. FIG. 5 is a front view of the imaging device shown in FIG. 3. FIG. 6 is a rear view of the imaging device shown in FIG. 3. FIG. 7 is a perspective view of the imaging device shown in FIG. 3, viewed from rear diagonally above. FIG. 8 is a perspective view of the imaging device shown in FIG. 3, viewed from rear diagonally above. FIGS. 9(A) and 9(B) are diagrams showing the imaging device, with the monitor casing turned. FIGS. 10(A) and 10(B) are diagrams showing the protective member for the main body casing. FIGS. 11(A) and 11(B) are perspective views of the monitor casing. FIG. 12 is a block diagram showing the control system of the imaging device.

As shown in FIG. 12, the imaging device 100 according to this example is constructed of the lens barrel 10 (having the imaging optical system 14 built therein) and the imaging element 150 composed of a CCD or MOS to capture the object image focused by the imaging optical system 14. In addition, the imaging device 100 also has the image processing unit 154 (which creates image data based on imaging signals supplied from the imaging element 150 and records them in the recording medium 152), the display processing unit 156 (which displays the image data on the display panel 126), the zoom drive unit 158 to change the magnification of the imaging optical system 14, and the control unit 160.

The control unit 160 includes the shutter button 110, the operation switch 112, the photographing start/stop button 114, the arrow pad 116, a plurality of operation switch 118, the reset switch 120, the image processing unit 154 which works according to the operation switches 128, and the CPU to control the zooming drive unit 158.

As shown in FIGS. 1 and 2, the imaging device 100 has the main body casing 50 and the monitor casing 60. Incidentally, in this specification, the right and left of the main body casing 50 are defined by viewing the main body casing 50 from rear.

The main body casing 50 is rectangular in shape having a certain thickness extending in the front and rear directions, a certain width which is larger than the thickness, and a certain length which is larger than the width.

The monitor casing 60 is rectangular in shape having a certain thickness extending in the front and rear directions, a certain width which is larger than the thickness, and a certain length which is larger than the width. In this example, the monitor casing 60 has the same width and length as the main body casing 50.

As shown in FIG. 2, the main body casing 50 and the monitor casing 60 are swingably joined together by the first pivot X1, which extends in their thickness direction, so that their insides face each other when not in use.

When not in use, the main body casing 50 and the monitor casing 60 take the closed form as shown in FIG. 2(F). When in use, the monitor casing 60 swings 90 degrees about the first pivot X1 from the main body casing 50, as shown in FIG. 2(G). The position of the monitor casing is indicated by the letter “a” when not in use and by the letter “b” when in use.

The monitor casing 60 is at the position “a” when not in use, and its contour coincides with that of the main body casing 50.

The monitor casing 60 is composed of two parts divided in the lengthwise direction. The first part is the first casing 62 in which there exists the first pivot X1. The second part is the second casing 64 which is swingably joined to the first casing 62 by the second pivot X2. The second casing 64 swings about the second pivot X2 with respect to the first casing 62.

As shown in FIGS. 3 to 5, the main body casing 50 has the inside 5004 and the outside 5002 (both intersecting the thickness direction), the top 5006 and the bottom 5008 (both intersecting the lengthwise direction), and the left lateral side 5010 and the right lateral side 5012 (both intersecting the widthwise direction).

The main body casing 50 has the lens barrel 10, which is open forward, at the upper part of the outside 5002 and at the center of the width.

The lens barrel 10 is composed of the lens barrel proper 12, the imaging optical system 14 held in the lens barrel proper 12, and the imaging element 30 (see FIG. 12). In this example, the imaging optical system 14 is a zoom lens capable of continuously changing magnification (between wide angle and telephoto).

The main body casing 50 has the flash unit 106 at the upper right corner on its outside 5002 and the light source 108 that emits auxiliary light for distance measurement.

The main body casing 50 has the strap eyelet 5014 on its top 5006.

As shown in FIG. 1(E), the main body casing 50 has the tripod socket 5016 at the left side of the bottom 5008. Next to the tripod socket 5016 is the lid (not shown) for the battery compartment.

As shown in FIG. 3, the main body casing 50 has, at its lower part on the left lateral side 5010, the recess 5019 to accommodate the connector (not shown) for transmission of signals to and from external units. The recess is provided with the lid 5022.

The imaging device in use (indicated by the letter “b”) is shown in FIGS. 6 and 7. The inside 5004 of the main body casing 50, which fits the first casing 62 and the second casing 64 when the imaging device is not in use, is exposed. The exposed part is composed of the peripheral part 5020 of the main body casing 50 and the bottom area 5022 which is lower than the peripheral part 5020. The bottom area 5022 is provided with several parts necessary for operation of the imaging device 100.

To be more specific, the inside 5004 of the main body casing 50, which fits the second casing 64 when the imaging device is not in use (indicated by the letter “a”), is exposed when the imaging device 100 is in use (indicated by the letter “b”). The bottom area 5022 of the exposed part is provided with the shutter bottom 110 to take static images, the zooming button 112 for the imaging optical system 14, and the start/stop button 114 to take dynamic images. They are arranged from left to right.

The bottom area 5022 of the exposed part has at its lower part the arrow pad 116 and several switches 118 to take and replay static and dynamic images.

The first casing 62 fits the inside 5004 of the main body casing 50 when the imaging device 100 is not in use as indicated by the letter “a”. The inside 5004 of the main body casing 50 is exposed when the imaging device 100 is in use as indicated by the letter “b”. The exposed bottom area 5022 of the main body casing 50 has the reset switch 120 at its upper right corner. The reset switch 120 is used to initialize the control unit 136 (See FIG. 12) that controls the imaging device 100.

The shutter button 110, operating switch 112, start/stop button 114, arrow pad 116, operating switches 118, and reset switch 120 mentioned in this example are defined as the operating members in the claims.

As shown in FIGS. 6 to 9, the peripheral part 5020 projects from the bottom area 5022 and the bottom area 5022 is flat and lower than the peripheral part 5020. There is a transient connecting curve between the bottom area 5022 and the peripheral part 5020.

In this example, the peripheral part 5020 and the main body casing 50 are formed from separate members, and the former is fixed into a groove formed in the outer edge in the latter. The member constituting the outer edge 5020 is composed of a first edge member 5202 and a second edge member 5204. The first edge member 5202 is formed from a flexible elastomer having a low coefficient of friction and the second edge member 5204 is formed from ABS resin. These two edge members are placed on top of the other and the assembly is bonded to the above-mentioned groove such that the first edge member 5202 projects toward the inside 5004.

The peripheral part 5020 comes into contact with the inside 6404 of the second casing 64 (or that part of the monitor casing 60 facing to the peripheral part 5020), so that it helps smooth rotation of the monitor casing 60 and protects the monitor casing 60 and the main body casing 50 from damage.

In addition, the shutter button 110, operating switches 112, start/stop button 114, arrow pad 116, and operating switches 118 are arranged in the inside 5004 such that their top is lower than the peripheral part 5020. This arrangement protects the inside 6004 and outside 6002 of the monitor casing 60 from coming into contact with each other, thereby damaging them each other.

As shown in FIG. 2, the monitor casing 60 consists of the first casing 62 and the second casing 64 arranged in the lengthwise direction. The first casing 62 has the first pivot X1 passing through it and the second casing 64 has the second pivot X2 which extends in the lengthwise direction of the first casing 62. The second pivot X2 permits the second casing 64 to swing about it. In this example, the second pivot X2 passes through the center of the width of the first casing 62 and the second casing 64.

The first casing 62 has the inside 6202 and the outside 6204 (both defining the thickness), the top 6206 and the bottom 6208 (both defining the length), and the left lateral side 6210 and the right lateral side 6212 (both defining the width).

The second casing 64 has the inside 6402 and the outside 6404 (both defining the thickness), the top 6406 and the bottom 6408 (both defining the length), and the left lateral side 6410 and the right lateral side 6412 (both defining the width).

The first casing 62 and the second casing 64 have the same width, and the second casing 64 is longer than the first casing.

The bottom 6208 and the top 6408 extend straight in the widthwise direction as viewed from the front or rear when the imaging device is not in use as indicated by the letter “a”. (The bottom 6208 is the end at which the first casing 62 faces to the second casing. The top 6406 is the end at which the second casing 64 faces to the first casing 62.)

As shown in FIG. 2(A), there is the recording microphone 122 (facing outward) on the outside 6204 of the first casing 62.

As shown in FIG. 2(A) and FIG. 3, there is the memory card slot 124 on the left lateral side 6210 of the first casing 62. The memory card slot 124 permits the memory card (or recording medium 152) to be inserted thereinto.

As shown in FIGS. 2 and 6 to 8, there is the rectangular display panel 126 on the inside 6402 of the second casing 64. The rectangular display panel 126 has its long side parallel to the length of the second casing 64 and its short side parallel to the width of the second casing 64.

The display panel 126 is a liquid crystal display, for instance. It has the rectangular display surface 126A which displays the static or dynamic images (taken by the lend barrel 10), letters, and symbols. It faces outward from the second casing 64 through the rectangular opening made in the inside 6402 of the second casing 64.

As shown in FIG. 2(G), there are several operating switches 128 (arranged in the widthwise direction) in the lower part of the inside 6402 of the second casing 64. The operating switches are intended for photographing and image replay.

As shown in FIG. 2(F), there is the speaker 130 on the outside 6404 of the second casing 64.

As shown in FIG. 11, the second casing 64 has the corners 6420 at both sides (in the widthwise direction) of the bottom 6408. These corners are made of synthetic resin, so that they do not damage the inside 5004 of the main body casing 50 in case of contact.

In what follows, a detailed description will be made of the main body casing 50 and the monitor casing 60.

As shown in FIGS. 2(F) and 2(G), the first pivot X1 is at one end of the length of the main body casing 50 and the monitor casing 60; in other words, it is at the position close to the top 5006 and 6206.

It is constructed such that, when the imaging device is in use as indicated by letter “b”, the left lateral side 6210 of the monitor casing 60 coincides with the top 5006 of the main body casing 50, as viewed from front.

The first pivot X1 is at a position close to the left lateral side 5010 displaced from the center of the width of the main body casing 50 so that, when the imaging device is in use as indicated by letter “b”, the second casing 64 is at a position outside the left lateral side 5010 of the main body casing 50.

The top 5006 of the first casing 62, which faces to the second casing 64 when the imaging device is in use as indicated by letter “b”, is at a position outside the left lateral side 5010 of the main body casing 50. That part of the first casing 62 (excluding the end of the first casing 62 facing to the second casing 64) is positioned above the main body casing 50.

In what follows, a description is made of the method for using the imaging device 100 according to this example.

The following description is made on the assumption that an object is photographed by using the imaging device 100.

As shown in FIG. 2(F), it is assumed that the monitor casing 60 is at the non-use position “a”.

The user holds the main body casing 50 with his one hand and holds the monitor casing 60 with his another hand. Then he swings the monitor casing 60 from the non-use position “a” to the use position “b”, as shown in FIG. 2(G).

The user holds the lower half of the main body casing 50, with the inside 5004 of the main body casing 50 facing to him, and turns the second casing 64 of the monitor casing 60 so that the display surface 126A faces to the user.

The user directs the imaging optical system 14 to an object and operates the shutter button 110 or start/stop button 114 while watching the object displayed on the display surface 126A.

During photographing, the user can direct the display surface 126A in any desired direction by turning the second casing 64 about the second pivot X2. For high-angle shots, the user holds the imaging device 100 high above his head while allowing the display surface 126A to face diagonally downward for easy watching. For low-angle shots, the user holds the imaging device 100 low below his head while allowing the display surface 126A to face diagonally upward for easy watching.

The user may also turn the second casing 64 about the second pivot X2 so that the display surface 126A and the imaging optical system 14 face in the same direction (forward). In this way it is possible for the user to take a picture of himself while watching himself displayed on the display surface 126A.

The following description is concerned with how to display an image on the display surface 126A.

It is possible to display an image on the display surface 126A, with the monitor casing 60 placed at the use position “b”. It is also possible to display an image on the display surface 126A, with the monitor casing 60 placed at the non-use position “a” (or the second casing 64 is turned so that the display surface 126A is facing opposite to the inside 5004 of the main body casing 50).

The following description is concerned with how to switch the imaging device 100 from its use position “b” to its non-use position “a”.

The user holds the main body casing 50 with his one hand and turns the second casing 64 of the monitor casing 60 with his another hand, so that the display surface 126A faces to the inside 5004 of the main body casing 50.

Then, the user turns the monitor casing 60 with his another hand from the non-use position “a” to the use position “b”. As the result, the main body casing 50 coincides with the monitor casing 60. Now, the imaging device is compact in size convenient to carry or store.

A description is given below of the working-effect of the imaging device 100 according to this example.

The imaging device 100 according to this example is constructed such that the first pivot X1 is at a position displaced toward the left lateral side 5010 (defining the width) from the center of the width of the main body casing 50, so that the second casing 64 is positioned outside the left lateral side 5010 (defining the width) of the main body casing 50, when the monitor casing 60 is at the use position “b”. This arrangement permits the second casing 64 to be made longer compared with the case in which the first pivot X1 is placed at the center of the width of the main body casing 50.

The effect of the forgoing is that the second casing 64 of the display panel 126 can be made large in the lengthwise direction. This is desirable for securing a large space for the display surface 126A of the display panel 126 while reducing the size of the main body casing 50 and the monitor casing 60.

In this example, the monitor casing 60 coincides with the main body casing 50 when the imaging device is at the non-use position. This arrangement is desirable for reducing the space occupied by the main body casing 50 and the monitor casing 60 when the imaging device 100 is at the non-use position “a”. It is also desirable for improved appearance.

The imaging device 100 in this example is constructed such that the first pivot X1 is at a position displaced to one end of the length of the main body casing 50 and the monitor casing 60, and that the left lateral side 6210 (defining the width of the monitor casing) at the use position “b” coincides with the top 5006 (defining the length) of the main body casing 50, as viewed from front or rear. This is desirable for space saving for the main body casing 50 and the monitor casing 60 at the use position “b”. It is also desirable for improved appearance.

In this example, as shown in FIGS. 6 and 7, there are the shutter button 110, the operating switch 112, the start/stop button 114, the arrow pad 116, and operating switches 118, which are arranged on the inside 5004 of the main body casing 50 with which the second casing 64 coincides at the non-use position “a”. They are exposed when the imaging device 100 is at the use position “b”. Therefore, they are covered by the monitor casing 60 when the monitor casing 60 is at the non-use position “a” and they are protected from erroneous operation.

In this example, as shown in FIG. 6, there occurs a dead space at the upper right corner of the inside 5004 of the main body casing 50 with which the lateral side of the first casing 62 coincides when the imaging device 100 is at the non-use position “a” and which is exposed when the imaging device 100 is at the use position “b”. However, this dead space may be utilized effectively for the reset switch 120 or the like, and this is desirable for size reduction of the imaging device 100.

Incidentally, in this example, if the monitor casing 60 is to be turned from the non-use position “a” to the use position “b” (or from the use position “b” to the non-use position “a”), it is necessary to swing the monitor casing 60 over the entire turning range of the monitor casing 60. However, any known toggle mechanism may be incorporated between the main body casing and the monitor casing so that when the monitor casing 60 is turned a prescribed amount of angle (say, 10 degrees) then it turns automatically the remaining angle (say, 80 degrees). This arrangement is desirable for easy operation of the monitor casing 60.

Also, in this example, it is assumed that the imaging device 100 is cable of taking both static and dynamic images; however, the present invention is applicable to the one which takes either static images or dynamic images. Also, the present invention is applicable to the portable telephone into which the imaging device is incorporated.

### EXAMPLE 2

A description is given below of the portable telephone into which the imaging device is incorporated.

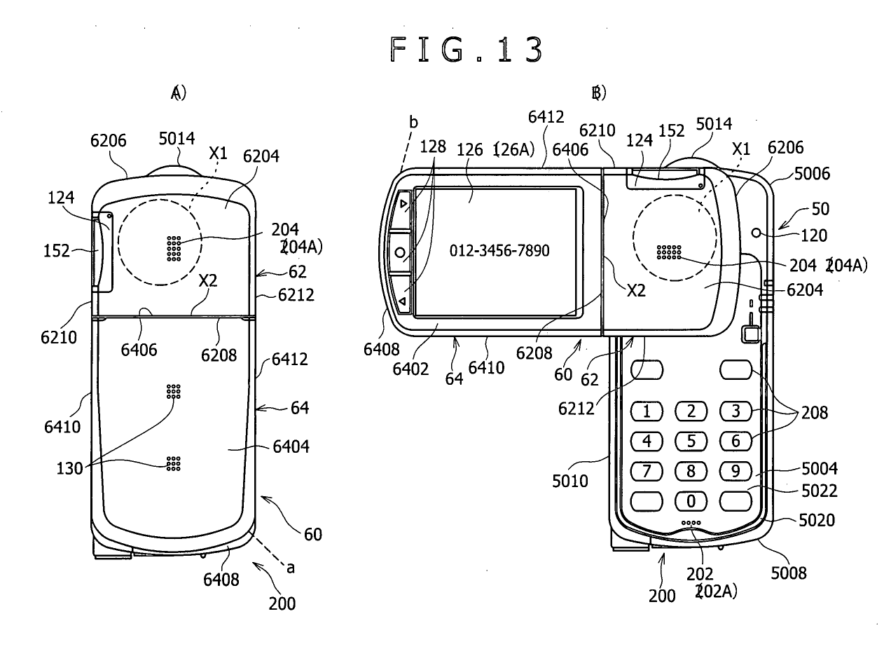

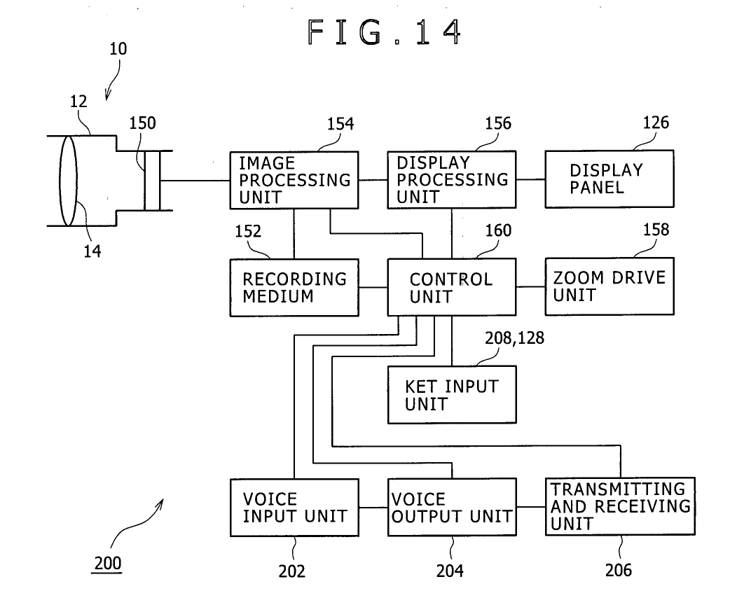

FIG. 13(A) is a rear view of the portable telephone. FIG. 13(B) is a diagram showing the portable telephone, with monitor casing swung 90 degrees. FIG. 14 is a block diagram showing the control system of the portable telephone. The same symbols are used for the same members in Example 1.

As shown in FIG. 14, the portable telephone 200 according to Example 2 is a portable telephone into which an imaging device is incorporated. It has the portable telephone unit that achieves the function of the portable telephone 200. The portable telephone unit consists of the voice input unit 202, the voice output unit 204, the transmitting and receiving unit 206 to transmit and receive voice or data through wireless circuit, the key input unit 208 to enter numerals, letters, or symbols or to perform various operations for the portable telephone, the display panel 126, the control unit 160, the shutter button (not shown) to take static images, the operating switches (not shown) to perform zooming operation for the image taking optical system 14 (see FIG. 14), and the start/stop button (not shown) to take dynamic images.

The control unit 160 controls the transmitting and receiving unit 206 according to the input by the key input unit 208, thereby performing transmission and reception; it also controls the voice input unit 202 and the voice output unit 204, thereby performing telephone communications. The control unit 160 also displays the entered telephone number and letters on the display panel 126.

In addition, the portable telephone 200 has the imaging device which, in the same way as in Example 1, consists of the lens barrel 10, the imaging element 10, the image processing unit 154, the display processing unit 156, and zoom driving unit 158.

As shown in FIGS. 13(A) and 13(B), the portable telephone 200 has the main body casing 50 and the monitor casing 60 as in the imaging device 100 in Example 1. The main body casing 50 and the monitor casing 60 are swingably joined together by the first pivot X1, which extends in their thickness direction, so that their insides face each other.

As shown in FIG. 13(A), the main body casing 50 and the monitor casing 60 are swingably joined together by the first pivot X1, so that they take on the non-use position “a” in which their lengthwise direction coincide with each other or the use position “b” in which their lengthwise directions form an angle of 90 degrees.

At the non-use position “a”, the contour of the monitor casing 60 coincides with the contour of the main body casing 50.

The monitor casing 60 is composed of two parts divided in the lengthwise direction. The first part is the first casing 62 in which there exists the first pivot X1. The second part is the second casing 64 which is swingably joined to the first casing 62 by the second pivot X2. The second casing 64 swings about the second pivot X2 with respect to the first casing 62.

The main body casing 50 has the lens barrel 10, which is open forward, at the upper part of the outside 5002 and at the center of the width.

The lens barrel 10 is composed of the lens barrel proper 12, the imaging optical system 14 held in the lens barrel proper 12, and the imaging element 30. In this example, the imaging optical system 14 is a zoom lens capable of continuously changing magnification (between wide angle and telephoto).

The main body casing 50 has the flash unit 106 at the upper right corner on its outside 5002 and the light source 108 that emits auxiliary light for distance measurement.

The main body casing 50 has the strap eyelet 5014 on its top 5006.

As shown in FIG. 1(E), the main body casing 50 has the tripod socket 5016 at the left side of the bottom 5008. Next to the tripod socket 5016 is the lid (not shown) for the battery compartment.

As shown in FIG. 3, the main body casing 50 has, at its lower part on the left lateral side 5010, the recess 5019 to accommodate the connector (not shown) for transmission of signals to and from external units. The recess is provided with the lid 5022.

The imaging device in use (indicated by the letter “b”) is shown in FIG. 13. The inside 5004 of the main body casing 50, which fits the first casing 62 and the second casing 64 when the imaging device is not in use, is exposed. The exposed part is composed of the peripheral part 5020 of the main body casing 50 and the bottom area 5022 which is lower than the peripheral part 5020. The bottom area 5022 is provided with several parts (keys) necessary for operation of the portable telephone 200. These keys constitute the input unit 208. At the lower part of the bottom area 5022 is the microphone 202A (facing outward) constituting the voice input unit 202.

To be more specific, the inside 5004 of the main body casing 50, which fits the second casing 64 when the imaging device is not in use (indicated by the letter “a”), is exposed when the imaging device 100 is in use (indicated by the letter “b”). The bottom area 5022 of the exposed part is provided with the above-mentioned several keys.

The first casing 62 fits the inside 5004 of the main body casing 50 at the non-use position “a”. The inside 5004 of the main body casing 50 is exposed at the use position “b”. The exposed bottom area 5022 of the main body casing 50 has the reset switch 120 at its upper right corner. The reset switch 120 is used to initialize the control unit 136 that controls the portable telephone 200.

The above-mentioned shutter button, zoom operating switch, and start/stop button are arranged on the left side 5010, the right side 5012, the top 5006, or the bottom 5022 of the main body casing 50.

The keys, reset switch 120, shutter button, operating switch, start/stop button mentioned in this example are defined as the operating members in the claims.

As in Example 1, the peripheral part 5020 projects from the bottom area 5022 and the bottom area 5022 is flat and lower than the peripheral part 5020. There is a transient connecting curve between the bottom area 5022 and the peripheral part 5020.

In this example, the peripheral part 5020 and the main body casing 50 are formed from separate members, and the former is fixed into a groove formed in the outer edge in the latter. The member constituting the outer edge 5020 is composed of a first edge member 5202 and a second edge member 5204. The first edge member 5202 is formed from a flexible elastomer having a low coefficient of friction and the second edge member 5204 is formed from ABS resin. These two edge members are placed on top of the other and the assembly is bonded to the above-mentioned groove such that the first edge member 5202 projects toward the inside 5004. (See FIGS. 10(A) and 10(B).)

The peripheral part 5020 comes into contact with the inside 6404 of the second casing 64 (or that part of the monitor casing 60 facing to the peripheral part 5020), so that it helps smooth rotation of the monitor casing 60 and protects the monitor casing 60 and the main body casing 50 from damage.

In addition, the keys, shutter button, and start/stop button are arranged on the bottom area 5022 such that their top is lower than the peripheral part 5020. This arrangement protects the inside 6004 and outside 6002 of the monitor casing 60 from coming into contact with each other, thereby damaging them each other.

As shown in FIG. 13, the monitor casing 60 consists of the first casing 62 and the second casing 64 arranged in the lengthwise direction. The first casing 62 has the first pivot X1 passing through it and the second casing 64 has the second pivot X2 which extends in the lengthwise direction of the first casing 62. The second pivot X2 permits the second casing 64 to swing about it. In this example, the second pivot X2 passes through the center of the width of the first casing 62 and the second casing 64.

The first casing 62 and the second casing 64 have the same width, and the second casing 64 is longer than the first casing 62.

The bottom 6208 and the top 6408 extend straight in the widthwise direction as viewed from the front or rear at the non-use position “a”. (The bottom 6208 is the end at which the first casing 62 faces to the second casing. The top 6406 is the end at which the second casing 64 faces to the first casing 62.)

As shown in FIG. 13(A), there is the voice output unit 204 (facing outward) on the outside 6204 of the first casing 62.

As shown in FIG. 2(A) and FIG. 3, there is the memory card slot 124 on the left lateral side 6210 of the first casing 62. The memory card slot 124 permits the memory card (or recording medium 152) to be inserted thereinto.

As shown in FIG. 2, there is the rectangular display panel 126 on the inside 6402 of the second casing 64. The rectangular display panel 126 has its long side parallel to the length of the second casing 64 and its short side parallel to the width of the second casing 64.

As in Example 1, the display panel 126 has the rectangular display surface 126A which faces outward from the second casing 64 through the rectangular opening made in the inside 6402 of the second casing 64.

As shown in FIG. 13(B), there are several operating switches 128 (arranged in the widthwise direction) in the lower part of the inside 6402 of the second casing 64. The operating switches are intended for photographing and image replay.

As shown in FIG. 13(A), there is the speaker 130 on the outside 6404 of the second casing 64.

As shown in FIG. 11, the second casing 64 has the corners 6420 at both sides (in the widthwise direction) of the bottom 6408. These corners are made of synthetic resin, so that they do not damage the inside 5004 of the main body casing 50 in case of contact.

In what follows, a detailed description will be made of the main body casing 50 and the monitor casing 60.

As shown in FIGS. 13(A) and 13(B), the first pivot X1 is at one end of the length of the main body casing 50 and the monitor casing 60; in other words, it is at the position close to the top 5006 and 6206.

It is constructed such that, when the imaging device is in use as indicated by letter “b”, the left lateral side 6210 of the monitor casing 60 coincides with the top 5006 of the main body casing 50, as viewed from front.

The first pivot X1 is at a position close to the left lateral side 5010 displaced from the center of the width of the main body casing 50 so that, when the imaging device is in use as indicated by letter “b”, the second casing 64 is at a position outside the left lateral side 5010 of the main body casing.

The top 5006 of the first casing 62, which faces to the second casing 64 when the imaging device is in use as indicated by letter “b”, is at a position outside the left lateral side 5010 of the main body casing. That part of the first casing 62 (excluding the end of the first casing 62 facing to the second casing 64) is positioned above the main body casing 50.

In what follows, a description is made of the method for using the portable telephone 200 according to this example.

The following description is made on the assumption that the portable telephone is used for telephone conversation.

As shown in FIG. 13(A), it is assumed that the monitor casing 60 is at the non-use position “a”.

The user holds the main body casing 50 with his one hand and holds the monitor casing 60 with his another hand. Then he swings the monitor casing 60 from the non-use position “a” to the use position “b”, as shown in FIG. 13(B).

The user holds the lower half of the main body casing 50, with the inside 5004 of the main body casing 50 facing to him, and turns the second casing 64 of the monitor casing 60 so that the display surface 126A faces to the user.

The user operates the key entry unit 208 while watching the display surface 126A, thereby entering the telephone number of his party or making the portable telephone ready for reception. He pushes the speaker 204A to his ear and brings the microphone 202A close to his mouth to make telephone conversation.

In what follows, a description is made of the method for taking pictures by using the portable telephone 200.

As shown in FIG. 13(A), it is assumed that the monitor casing 60 is at the non-use position “a”.

The user holds the main body casing 50 with his one hand and holds the monitor casing 60 with his another hand. Then he swings the monitor casing 60 from the non-use position “a” to the use position “b”, as shown in FIG. 13(B).

The user holds the lower half of the main body casing 50, with the inside 5004 of the main body casing 50 facing to him, and turns the second casing 64 of the monitor casing 60 so that the display surface 126A faces to the user.

The user directs the imaging optical system 14 to an object and operates the shutter button or start/stop button while watching the object displayed on the display surface 126A.

During photographing, the user can direct the display surface 126A in any desired direction by turning the second casing 64 about the second pivot X2. For high-angle shots, the user holds the portable telephone 200 high above his head while allowing the display surface 126A to face diagonally downward for easy watching. For low-angle shots, the user holds the portable telephone 200 low below his head while allowing the display surface 126A to face diagonally upward for easy watching.

The user may also turn the second casing 64 about the second pivot X2 so that the display surface 126A and the imaging optical system 14 face in the same direction (forward). In this way it is possible for the user to take a picture of himself while watching himself displayed on the display surface 126A.

In the case where the above-mentioned shutter button or the start/stop button is arranged on the left lateral side 5010, or the right lateral side 5012, or the top 5006 of the main body casing 50, the user turns the second casing 64 so that the monitor casing 60 is at the non-use position “a”, with the display surface 126A facing in the direction opposite to the inside 5004 of the main body casing 50, and the display surface 126A displays the image. Thus, the user can take pictures by operating the shutter button or the start/stop button.

The following description is concerned with how to display an image on the display surface 126A.

It is possible to display an image on the display surface 126A, with the monitor casing 60 placed at the use position “b”. It is also possible to display an image on the display surface 126A, with the monitor casing 60 placed at the non-use position “a” (or the second casing 64 is turned so that the display surface 126A is facing opposite to the inside 5004 of the main body casing 50).

The following description is concerned with how to switch the portable telephone 200 from its use position “b” to its non-use position “a”.

The user holds the main body casing 50 with his one hand and turns the second casing 64 of the monitor casing 60 with his another hand, so that the display surface 126A faces to the inside 5004 of the main body casing 50.

Then, the user turns the monitor casing 60 with his another hand from the non-use position “a” to the use position “b”. As the result, the main body casing 50 coincides with the monitor casing 60. Now, the imaging device is compact in size convenient to carry or store.

A description is given below of the working-effect of the portable telephone 200 according to Example 2.

The portable telephone 200 according to Example 2 is constructed such that the first pivot X1 is at a position displaced toward the left lateral side 5010 (defining the width) from the center of the width of the main body casing 50, so that the second casing 64 is positioned outside the left lateral side 5010 (defining the width) of the main body casing 50, when the monitor casing 60 is at the use position “b”. This arrangement permits the second casing 64 to be made longer compared with the case in which the first pivot X1 is placed at the center of the width of the main body casing 50.

The effect of the forgoing is that the second casing 64 of the display panel 126 can be made large in the lengthwise direction. This is desirable for securing a large space for the display surface 126A of the display panel 126 while reducing the size of the main body casing 50 and the monitor casing 60.

In Example 2, the monitor casing 60 coincides with the main body casing 50 when the portable telephone 200 in at the non-use position “a”. This is desirable for reducing the space for the main body casing 50 and the monitor casing 60 when the portable telephone 200 is at the non-use position. It is also desirable for improved appearance.

The portable telephone 200 in Example 2 is constructed such that the first pivot X1 is at a position displaced to one end of the length of the main body casing 50 and the monitor casing 60, and that the left lateral side 6210 (defining the width of the monitor casing) at the use position “b” coincides with the top 5006 (defining the length) of the main body casing 50, as viewed from front or rear. This is desirable for space saving for the main body casing 50 and the monitor casing 60 at the use position “b”. It is also desirable for improved appearance.

In Example 2, as shown in FIG. 13, there are the operating members arranged on the inside 5004 of the main body casing 50 with which the second casing 64 coincides at the non-use position “a”. They are exposed when the portable telephone 200 is at the use position “b”. Therefore, they are covered by the monitor casing 60 when the monitor casing 60 is at the non-use position “a” and they are protected from erroneous operation.

In Example 2, as shown in FIG. 13, there occurs a dead space at the upper right corner of the inside 5004 of the main body casing 50 with which the lateral side of the first casing 62 coincides when the portable telephone 200 is at the non-use position “a” and which is exposed when the portable telephone 200 is at the use position “b”. However, this dead space may be utilized effectively for the reset switch 120 or the like, and this is desirable for size reduction of the portable telephone 200.

Incidentally, in Example 2, if the monitor casing 60 is to be turned from the non-use position “a” to the use position “b” (or from the use position “b” to the non-use position “a”), it is necessary to swing the monitor casing 60 over the entire turning range of the monitor casing 60. However, any known toggle mechanism may be incorporated between the main body casing and the monitor casing so that when the monitor casing 60 is turned a prescribed amount of angle (say, 10 degrees) then it turns automatically the remaining angle (say, 80 degrees). This arrangement is desirable for easy operation of the monitor casing 60.

Also, in Example 2, it is assumed that the portable telephone 200 is cable of taking both static and dynamic images; however, the present invention is applicable to the one which takes either static images or dynamic images.

It should be understood by those skilled in the art F that various modifications, combinations, sub-combinations and alterations may occur depending on design requirements and other factors insofar as they are within the scope of the appended claims or the equivalents thereof.
FIGS. 12, 14
image processing unit 154
display processing unit 156
display panel 126
recording medium 152
control unit 160
zoom drive unit 158
operation switch 112
shutter button 110
key input unit 208
voice input unit 202
voice output unit 204
transmitting and receiving unit 206

1. An imaging device comprising:
a main body casing of elongate shape with a thickness, a width larger than the thickness, and a length larger than the width, and
a monitor casing of elongate shape with a thickness, a width larger than the thickness, and a length larger than the width,
the main body casing and the monitor casing being joined together such that they swing about a first pivot extending in a direction of the thickness so that an inside of the main body casing and an inside of the monitor casing face each other,
the monitor casing being divided in its lengthwise direction into a first casing in which there exists the first pivot and a second casing that is joined to the first casing by a second pivot extending in a lengthwise direction such that the second casing swings about the second pivot with respect to the first casing,
the main body casing having on an outside thereof a lens barrel and the second casing having on an inside thereof a display surface to display an image taken by the lens barrel,
the main body casing and the monitor casing swinging relative to each other about the first pivot between a non-use position, at which they coincide with each other in their lengthwise direction, and a use position, at which their lengthwise directions form an angle of 90 degrees, and
the first pivot being displaced from a center of the width of the main body casing so that the second casing at the use position is positioned outside a lateral side of the main body casing.

2. The imaging device as defined in claim 1, wherein the monitor casing is equal to the main body casing in width and length, and a contour of the main body casing coincides with contour of the monitor casing in the non-use position.

3. The imaging device as defined in claim 1, wherein the first pivot is placed at a position close to one end of the length of both the main body casing and the monitor casing.

4. The imaging device as defined in claim 1, wherein the first pivot is placed at a position close to one end of the length of both the main body casing and the monitor casing, and one lateral side of the monitor casing coincides with the one end of the main body casing in their use position.

5. The imaging device as defined in claim 1, wherein both an end of the first casing that faces the second casing and an end of the second casing that faces the first casing extend straight in the widthwise direction.

6. The imaging device as defined in claim 1, wherein the first pivot is at a position close to one end of the length of both the main body casing and the monitor casing, both the end of the first casing that faces the second casing and the end of the second casing which faces to the first casing extend straight in the widthwise direction, and, in the use position, the end of the first casing facing the second casing is positioned outside the lateral side at one position in the widthwise direction of the main body casing and the remaining part of the first casing excluding the end of the first casing facing the second casing is positioned above the main body.

7. The imaging device as defined in claim 1, wherein, in the use position, the inside area of the main body casing with which the second casing coincides in the non-use position and the inside area of the main body casing with which one lateral side in the widthwise direction of the first casing coincides in the non-use position are exposed, and these areas are provided with operating members to operate the imaging device.

8. The imaging device as defined in claim 1, wherein the first casing and the second casing are equal in width and the second casing is longer than the first casing.

9. The imaging device as defined in claim 1, wherein the second pivot passes through the center of the width of both the first casing and the second casing.

10. The imaging device as defined in claim 1, wherein, in the use position, the inside area of the main body casing with which the second casing coincides in the non-use position and the inside area of the main body casing with which one lateral side in the widthwise direction of the first casing coincides in the non-use position are exposed, and these areas are composed of a peripheral part positioned at a periphery of the main body casing and a bottom part that is inside the peripheral part and is lower than the peripheral part, and the bottom part is provided with operating members to operate the imaging device.

11. A portable telephone comprising:
a main body casing of elongate shape with a thickness, a width larger than the thickness, and a length larger than the width, and
a monitor casing of elongate shape with a thickness, a width larger than the thickness, and a length larger than the width,
the main body casing and the monitor casing being joined together such that they swing about a first pivot extending in a direction of the thickness so that an inside of the main body casing and an inside of the monitor casing face each other,
the monitor casing being divided in its lengthwise direction into a first casing in which there exists the first pivot and a second casing that is joined to the first casing by a second pivot extending in a lengthwise direction such that the second casing swings about the second pivot with respect to the first casing, the main body casing and the monitor casing swinging relative to each other about the first pivot between the non-use position, at which they coincide with each other in their lengthwise direction, and the use position, at which their lengthwise directions form an angle of 90 degrees,
the main body casing having on its outside a lens barrel and also having on that part of its inside, which is exposed at the use position operating members for operation of the portable telephone, and the second casing having on its inside a display surface to display an image taken by the lens barrel, and the first pivot being displaced from the center of the width of the main body casing so that the second casing at the use position is positioned outside the lateral side of the main body casing.

12. The portable telephone as defined in claim 11, further comprising a microphone at the end of the length inside the main body casing, and a speaker on the outside forming the other surface in the thickness direction of the first casing.
